(19) United States
(12) Patent Application Publication
(10) Pub. No.: US 2009/0308493 A1
(43) Pub. Date: Dec. 17, 2009

(54) Dispensing Device for Free-Flowing or Pourable Products

(75) Inventors: Martin Buchstab, Bopfingen (DE); Irene Dumkow, Sontheim (DE); Adolf Feinauer, Giengen (DE); Klaus Flinner, Zoschingen (DE); Bernd Heger, Haunsheim (DE); Peter Nalbach, Kirchheim/Nabern (DE); Kasim Yazan, Ulm (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERAETE GMBH, MUNICH (DE)

(21) Appl. No.: 12/085,938

(22) PCT Filed: Nov. 20, 2006
(86) PCT No.: PCT/EP2006/068669

§ 371 Date: May 28, 2008

(30) Foreign Application Priority Data
Nov. 30, 2005 (DE) 102005057152.2
Nov. 7, 2006 (DE) 202006017049.9

(51) Int. Cl. B67D 5/64; B67D 1/08

(52) U.S. Cl. 141/378; 222/173

(57) ABSTRACT

A dispensing device for free-flowing or pourable products, said device comprising a dispenser opening for the products, which is situated in a recess on the front of the device and at least one first tray surface for a tray part, which supports a container that is to be filled from the dispenser opening. The tray part can be controllably displaced in the recess between a first position, in which the first tray surface lies opposite the dispenser opening at a first distance and a second position, in which at least one tray surface lies opposite the dispenser opening at a second distance that is greater than the first.

The present invention relates to a dispensing device for dispensing free-flowing or pourable products, in particular cooled liquid and/or pieces of ice, into a container. Such a dispensing device is disclosed in GB 2 401 169 A, for example. In the case of this dispensing device, a dispenser opening is arranged in the upper region of a recess in which a container that is to be filled can be placed. A receptacle which serves to capture spilt filling product is located at the floor of the recess. In order to be able to empty and, if appropriate, clean the receptacle, it can be removed from the recess. Assuming the container that is to be filled has a suitable shape, said receptacle can also serve as a shelf surface for the container during filling.

In order to prevent spattering of the filling product while a container is being filled, the upper edge of the container must be placed as closely as possible beneath the dispenser opening. In this way, splashes which occur in the container when the filling product is at a low level do not usually come out of the container and, when the filling product level is high, the drop distance of the filling product is so small that splashes hardly occur. Containers which are placed in the recess for filling must therefore be adapted very precisely to the recess, both in their lateral dimensions and in height, in order that they can be filled without spillage. All other containers must be held manually beneath the dispenser opening, though this again increases the risk of spillage if the container is not held still.

The object of the invention is to provide a dispensing device for free-flowing or pourable products which allows containers of various dimensions to be filled without spillage.

The object is achieved by a dispensing device having a dispenser opening for the free-flowing or pourable products, said dispenser opening being situated in a recess at a front side of the dispensing device, and having a shelf part forming at least a first shelf surface for a container that is to be filled at the dispenser opening, wherein the shelf part can be moved at the recess between a first position, in which the first shelf surface lies opposite the dispenser opening at a first distance, and a second position in which a shelf surface lies opposite the dispenser opening at a second distance which is greater than the first distance.

Depending on the position of the shelf part, it is therefore possible reliably to fill containers having a height which is adapted to the first distance or to the second distance.

The shelf surface which lies opposite the dispenser opening at the second distance can be a second shelf surface which is concealed by the shelf part in the first position, such that it is revealed by moving the shelf part into the second position so that a container can be placed on it.

Alternatively, the shelf surface which lies opposite the dispenser opening at the second distance can also be the first shelf surface itself in the second position of the shelf part. For this purpose the guided movement of the shelf part is advantageously a parallel displacement or preferably a displacement on which a slight rotation is superimposed.

As a second alternative, the shelf surface which lies opposite the dispenser opening at the second distance can be a third shelf surface formed on the shelf part. In this case the guided movement of the shelf part can be essentially a pivoting movement.

The above alternatives can be combined with one another in such a way that a stationary second shelf surface revealed by the movement of the shelf part into the second position and a shelf surface of the support part can simultaneously lie opposite the dispenser opening at various distances, thereby producing additional options for placing containers of different sizes.

While the shelf part can be situated in the recess in the first position and therefore vertically beneath the dispenser opening, in the second position it is advantageously shifted at least partially out of the recess.

In particular but not only in the case of a shelf part shifted out of the recess in the second position, it is advantageous if a restoring element acts on the shelf part in its second position in order to return it to the first position. This avoids the shelf part projecting out of the recess for longer than necessary, and the risk that a user knocks against the shelf part and damages it or suffers injury in the process, is minimized.

In order nonetheless to enable the shelf part to be actuated and a container filled single-handedly, the shelf part is advantageously latchable in the second position.

According to a first embodiment the shelf part can be latched in the second position by means of a bar, and the bar can be moved by pressing a button in order to release the latch.

According to a second embodiment the shelf part can be latched in the second position by means of a single movement from the first position beyond the second position, and can be unlatched by means of a repeated movement beyond the second position.

In particular when the dispensing device is provided for being covered by a decor panel, for example when it is configured as a built-in appliance, it is advantageous if the shelf part is held at the recess by way of a sliding carriage which can be displaced in the depth direction of the recess. Said sliding carriage creates the possibility of advancing the shelf part forward out of the recess for the transition into its second position, so that it can pass through an opening in a decor panel attached to the front of the dispensing device and be brought beyond said opening through the decor panel unobstructed into the second position.

In order to simplify the use of the shelf part, a displacement of the sliding carriage is preferably coupled to the movement of the shelf part, the sliding carriage assuming a position retracted into the recess when the shelf part is in the first position, and a position extended out of the recess when the shelf part is in the second position.

The plurality of shelf surfaces permit a user to place a container that is to be filled on that shelf surface which is best suited to the height of the container. In this way the likelihood that filling product will be spilled or splashed during the filling operation is minimized. If filling product is nonetheless spilled, easy cleaning is assured by virtue of the fact that the base part—and with it the shelf part mounted thereon—can be removed from the recess and cleaned outside of the dispensing device, e.g. under running water.

The base part preferably lines at least a lower region of the recess. This prevents the walls of the recess itself from being splashed during operation and minimizes the amount of effort involved in cleaning the recess.

The base part can be guided in the recess by means of rails which extend in the withdrawal direction of the support part; alternatively or additionally, the base part and the recess can respectively comprise a pin and a socket which extend in the withdrawal direction of the base part.

In both cases, a simple pin extending at right angles relative to the withdrawal direction of the support part is sufficient to secure the installed base part in the recess.

The pin is preferably attached inconspicuously at a location which is concealed by the shelf part in the first position.

Further features and advantages of the invention may be derived from the following description of exemplary embodiments with reference to the accompanying figures, in which:

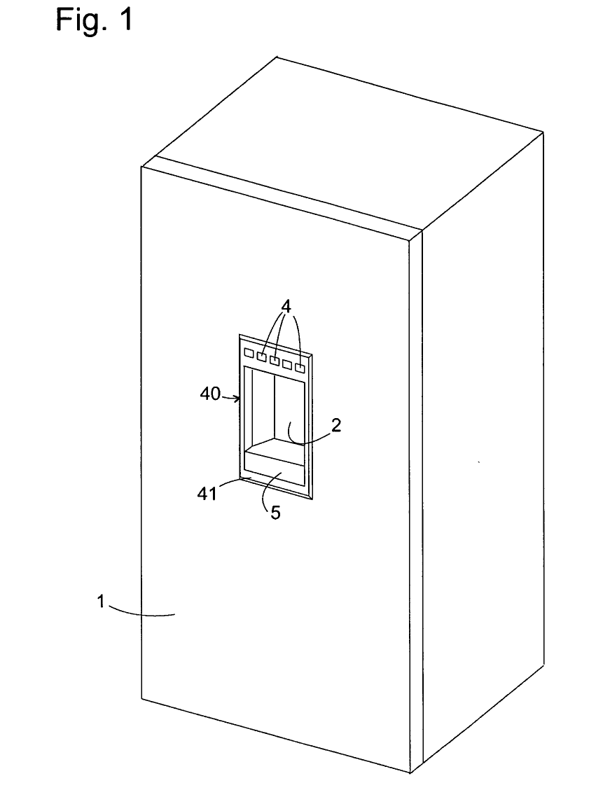

FIG. 1 shows a schematic view of a refrigeration appliance which is equipped with a dispensing device for ice and chilled water in accordance with the present invention;

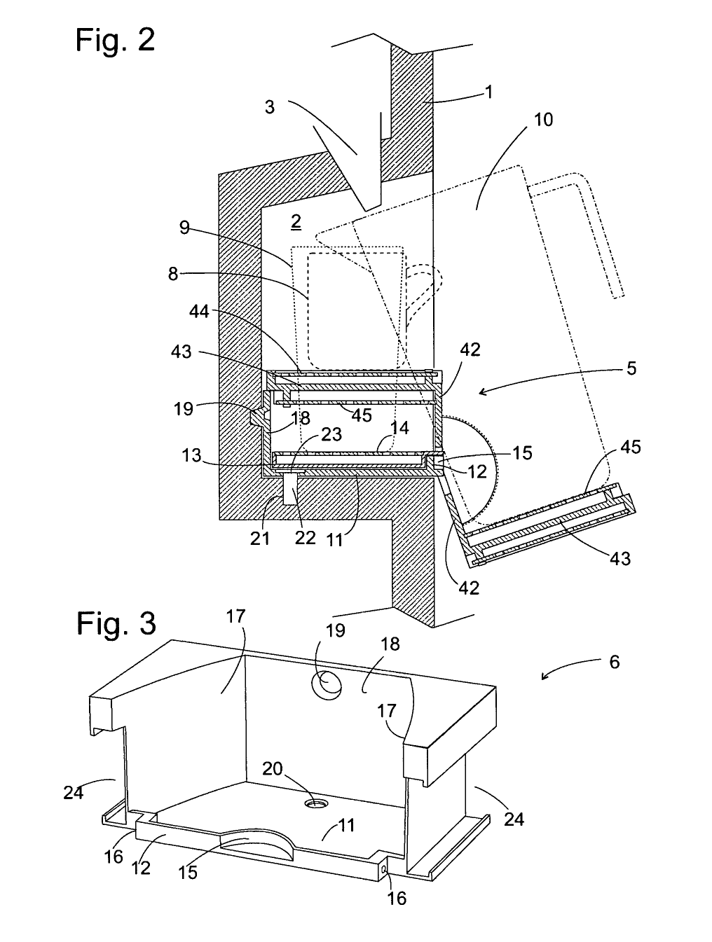

FIG. 2 shows a schematic section through a door of the refrigeration appliance, in which door the dispensing device is installed;

FIG. 3 shows a perspective view of the base part of the dispensing device;

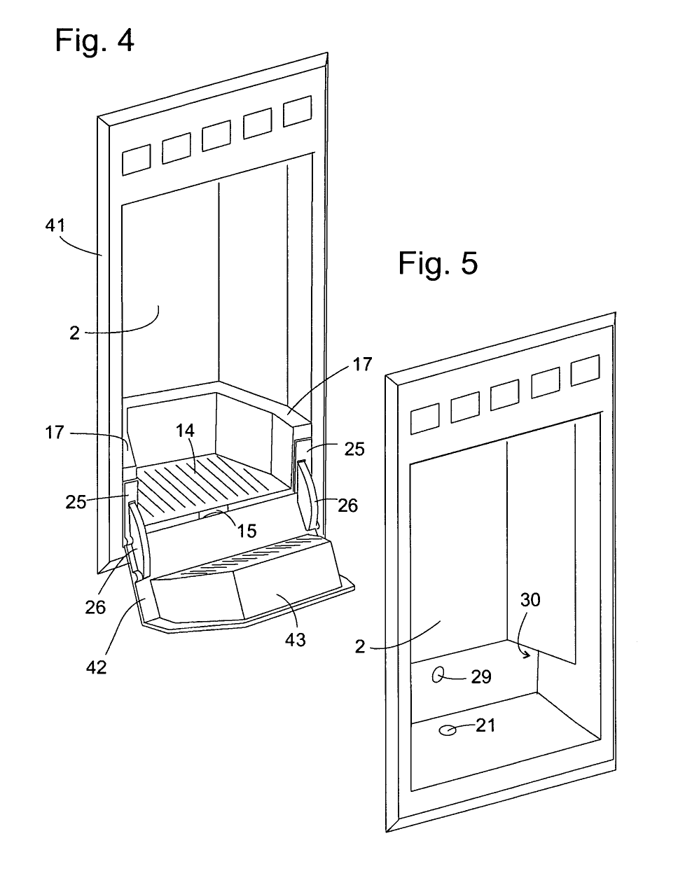

FIG. 4 shows a perspective view of the dispensing device with support in the swung-open position;

FIG. 5 shows a perspective view of the dispensing device from which the support is removed;

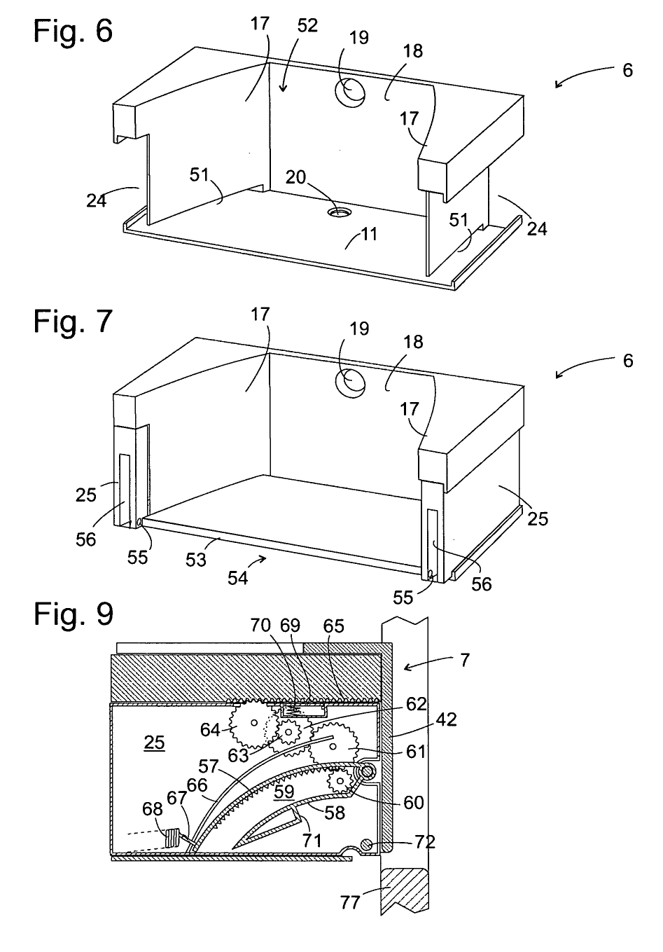

FIG. 6 shows a perspective view of a base part according to a second embodiment of the invention;

FIG. 7 shows the base part from FIG. 6 together with a sliding carriage mounted thereon;

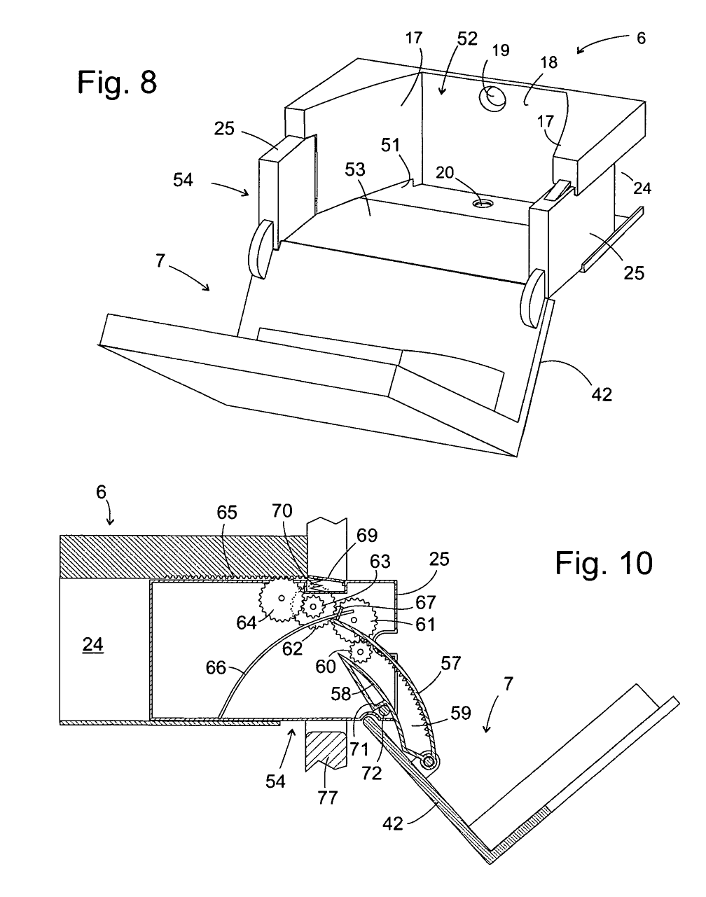

FIG. 8 shows an assembly consisting of the base part and the sliding carriage of FIG. 7 as well as a shelf part hinged to the sliding carriage in the swung-open position;

FIG. 9 shows a section through the assembly of FIG. 8 in the closed position;

FIG. 10 shows a section through the assembly of FIG. 8 in the open position;

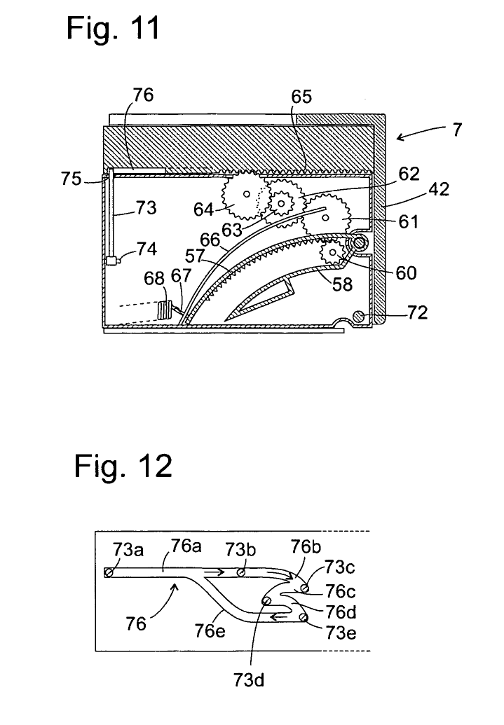

FIG. 11 shows a section through an alternative embodiment of the assembly in the closed position; and

FIG. 12 shows a guide groove of the assembly from FIG. 11.

FIG. 1 is a perspective view of a refrigeration appliance with a door 1 in which a dispensing device for water and ice is installed. A window is cut into the center of the outer skin of the door 1, and a plastic housing 40 that is open to the front is inserted into said window. The housing delimits a recess 2 in which a dispenser opening (not visible in the figure) for water and ice is attached at the top and in which a container that is to be filled can be placed. A circumferential frame 41 of the housing 40 covers the window. An operating panel with a plurality of buttons 4 is formed in an upper region of the frame 41. A lower region of the recess 2 is filled by a support 5 whose function is explained further below.

FIG. 2 shows a section through the door 1 at the level of the recess 2. The dispenser opening for ice and/or chilled water is designated as 3.

The support 5 comprises two parts, a base part 6 and a shelf part 7, which are reciprocally pivotable about an axis which runs transversely relative to the sectional plane of FIG. 1. FIG. 2 shows the shelf part 7 simultaneously in two different stop positions of its pivot movement, a neutral position in which the shelf part 7 descends into the recess 2, as shown in FIG. 1 also, and a swung-out position in which the shelf part 7 is situated outside of the recess 2.

The shelf part 7 is roughly L-shaped in cross-section, having a front plate 42 which is vertical in the neutral position and extends across the whole width of the recess 2, and a tray 43 which is oriented at right angles relative to the front plate 42 and projects horizontally into the recess 2 in the neutral position, filling the entire cross-sectional area thereof. The top and bottom sides of the tray 43 are hollowed out, and the hollow spaces are covered in each case by a grating 44 or 45 which can be engaged in the tray 43 in a detachable manner. A container of modest height, such as e.g. a cup 8 shown by a broken line, can be placed on the top grating 44 at a short distance from the dispenser opening 3 in the neutral position.

In the swung-open position of the shelf part 7, the base part 6 is exposed.

FIG. 3 shows a perspective view of the base part 6. The base part 6 has roughly the shape of a cuboid box with open top and front sides. The floor plate 11 of the box is delimited on the front side by a narrow ridge 12 in order to form a flat receptacle in which a drip catcher can be placed. The drip catcher is shown in FIG. 2. It comprises a flat receptacle 13, the open top side of which is covered by a grating 14. A notch 15 over which an edge of the receptacle 13 projects is formed in the center of the ridge 12 such that in the swung-open position of the support 5 the drip catcher can be conveniently removed and emptied.

Two blind holes 16 are collinearly formed in a section of the ridge 12 which juts out beyond the front side of the door 1, and are provided in each case for the purpose of receiving shaft pieces that function as spindles for the pivot movement of the shelf part 7.

In the swung-open position, an average-sized container such as e.g. a beaker 9 can be placed in the recess 2 directly on the drip catcher of the base part 6, or a large container such as e.g. a jug 10 can be placed on the grating 45 of the shelf part 7, this being oriented obliquely upward in the swung-open position, in a position in which the opening of the jug 10 projects into the recess 2 while its base rests on the shelf part 7 outside of the recess 2. The height of the jug can therefore be greater than the height of the recess 2 by approximately the height of the front plate 41.

Side walls 17 and a rear wall 18 of the base part 6 protect the interior of the recess 2 from splashes which can occur if filling product is spilt in the swung-open position of the shelf part 7 or drips directly from the dispenser opening 3 onto the grating 14.

A projection 19 is also formed on the rear wall 18, extending in the depth direction of the recess 2 and engaging in a reciprocal cavity in the rear wall of the recess 2 when the support 5 is correctly positioned in the recess 2.

When the support 5 is correctly positioned, an opening 20 which is formed in the floor plate 11 is also aligned with a cavity 21 in the floor of the recess 2 such that, as shown in FIG. 1, a locking pin 22 can be introduced through the opening 20 into the cavity 21. The locking pin 22 can be a screw which engages in a thread of the cavity 21, but can also be a simple cylindrical or tapered pin featuring a widened head 23 for greater ease of handling. As a result of the engagement of the projection 19 and the pin 22 into the respectively assigned cavities of the recess 2, the support 5 is immovably fixed in the recess 2 and therefore capable in the swung-open-position of holding a heavy container such as a jug 10 without falling out of the recess 2.

Insertion slots 24 are formed in the wide side walls 17 of the base part 6, and are provided for accommodating a mechanism module 25 (see FIG. 4) in each case. The inside of the mechanism modules 25 contains in each case a toothed wheel which is braked by means of friction, a flywheel or similar, and meshes with a toothed wheel segment 26 at the front plate 42 of the shelf part 7. A spring can also be provided in the mechanism modules 25 in each case, which spring applies pressure to the shelf part 7 in the direction of its swung-closed position and is strong enough to swing the shelf part 7 closed if the latter is not loaded by a vessel that is to be filled.

FIG. 5 shows the recess 2 without the support 5 therein. The cavity 22 in the floor of the recess 2 and the cavity (identified by 29 in the figure) which accommodates the projection 19 in the rear wall are visible. Also visible is one of two cavities 30 which are located opposite each other in the side walls of the recess 2. The cavities 30 accommodate rear corners of the side walls of the base part 6, thereby forming a rail-type guide in which the base part is movably guided in the depth direction of the recess.

FIG. 6 shows a perspective view of a base part 6 according to a second embodiment of the invention. Elements corresponding to those of the base part 6 from FIG. 3 are identified by the same reference signs in the figure and are not described again. The ridge 12 delimiting the floor plate 11 has been omitted; the front edge of the floor plate 11 lies in the same plane as front edges of the side walls 17; formed at the foot of each of the side walls 17 between the latter and the floor plate 11 is a gap 51 which connects the lateral insertion slots 24 to a central interior space 52 of the base part 6.

Extending through the gaps 51 there is, as shown in FIG. 7, a floor plate 53 which combines the mechanism modules 25 that are inserted into the two insertion slots 24 into an intrinsically rigid sliding carriage 54. Whereas in the embodiment of FIGS. 1 to 5 the mechanism modules 25 are immovably accommodated in the insertion slots 24, according to this embodiment they can be displaced in the depth direction. The connection of the mechanism modules by means of the floor plate 53 ensures that both are moved in parallel with each other and to the same extent. As on the floor plate 11 of the first embodiment, a receptacle (not shown in FIG. 7) covered by a grating and provided for catching splash water can be disposed on the floor plate 53.

The position shown in FIG. 7, in which the mechanism modules 25 are completely housed in the insertion slots 24, corresponds to a closed position of the shelf part 7. Since in this position the shelf part conceals the mechanism modules 25 exactly like the shelf part 7 of the first embodiment, it has been omitted in FIG. 7 so that the mechanism modules 25 can be shown.

FIG. 8 shows the base part 6 with the sliding carriage 54 and the shelf part 7 pivotably suspended on the sliding carriage in the open position. It can be seen that in this position the sliding carriage 54 is pushed forward out of the base part 6 and the mechanism modules 25 are partially disengaged from the insertion slots 24. The axis of rotation of the shelf part 7, which axis is specified by spindle receiving openings 55 (shown located opposite each other in FIG. 6) of the two mechanism modules 25, is thus moved forward compared to the position of FIG. 7. This enables the shelf part 7 to be swiveled downward into the open position even when its front plate 42 springs back in the closed position behind an adjacent vertical surface, in particular the external surface of a decor panel in the case of a built-in appliance.

FIGS. 9 and 10 each show a section through the assembly of FIG. 8 at the level of one of its mechanism modules 25 in the closed and open position respectively. The two mechanism modules are constructed mirror-symmetrically to each other. The sectional plane of FIGS. 9, 10 extends through a slot 56 formed at the front side of each of the mechanism modules 25. A curved toothed rack 57 pivotally hinged to the front plate 42 of the shelf part 7 engages through said slot 56 into the interior of the mechanism modules 25. The toothed rack 57 is connected in a one-piece and rigid manner to a wall 58 located opposite it through a wall running outside of the sectional plane and parallel thereto. Together with the wall 58, the toothed rack 57 delimits a channel 59 of essentially constant width into which engages a toothed wheel 60 that is rotatable about a fixed axis relative to the housing of the mechanism module 25. Through contact with the toothed wheel 60 the wall 58 prevents the toothed wheel 60 from disengaging from the teeth of the toothed rack 57 if a force acts between the toothed wheel 60 and the toothed rack 57. Thus, if the shelf part 7 is folded forward and the toothed rack 57 is withdrawn from the mechanism module 25, the toothed wheel 60 is set into rotation.

Via a reduction gear mechanism having toothed wheels 61, 62, 63, the toothed wheel 60 drives a toothed wheel 64 which in turn meshes with a toothed rack 65 which is formed at the base part 6 at the top of the insertion slot 24 housing the mechanism module 25. The rotation of the toothed wheel 64 driven by the swinging-up movement of the shelf part 7 thus drives the mechanism module 25 forward from the insertion slot 24 and thereby shifts the axis of rotation of the shelf part 7.

Two ribs 66 supported on the side surfaces of the housing of the mechanism module 25 run diagonally from top to bottom through the interior of the mechanism module 25. The sectional plane of FIGS. 9 and 10 runs through a gap between the two opposing ribs 66. Through this gap there extends a projection 67 of the toothed rack 57 on which a return spring 68 engages. The return spring 68 exerts a tractive force on the toothed rack 57 which counteracts a pivoting movement of the shelf part 7 into the open position.

Disposed on the top side of the mechanism module 25 is a pivotable bar 69 which is forced against the top of the insertion slot 24 by a spring 70. The bar is wider than the toothed rack 57 formed at the top of the insertion slot 24 so that it does not catch in inter-teeth spaces of the toothed rack 57 when the sliding carriage 54 is displaced.

A furniture panel which is attached to the front of the refrigeration appliance door which accommodates the assembly consisting of base part 6, sliding carriage 54 and support part 7 is identified by 77. As can be seen, the base part 7 could not be pivoted appreciably beyond 90° while maintaining the position of its axis of rotation shown in FIG. 9.

FIG. 10 shows the assembly with the shelf part 7 in the swung-out position. The spindles 72 which define the axis of rotation project beyond the furniture panel 77 such that the latter places practically no restriction on the freedom of pivoting movement. The curved toothed rack 57 is largely retracted from the mechanism module 25 and its projection 67 is located close to an upper end of the ribs 66. The return spring 68 (not shown in FIG. 10) is under strong tension. A projection 71 formed on the underside of the wall 58 butts against a spindle 72 of the shelf part 7 which engages through the spindle receiving opening 55 into the mechanism module 25, and thereby defines a stop position beyond which the shelf part 7 cannot be pivoted.

When the shelf part 7 has reached said stop position, the propulsion of the sliding carriage 54 is just great enough that the bar 69 is fully extended out of the insertion slot 24 and a rear end of the bar 69 is raised somewhat by means of the spring 70. If the user releases the shelf part 7 in this position, the return spring 68 actually exerts a tractive force on the curved toothed rack 57 in order to return the shelf part 7 to the closed position, but since at the same time the bar 69 is pressed against the base part 6, the shelf part 7 cannot swing back. The shelf part 7 is thus anchored in the position shown in FIG. 10. The user can therefore place a vessel that is to be filled on the shelf part 7 or in the base part 6 without having to hold the shelf part 7 steady.

With the user pressing down the bar 69 after the vessel has been filled, the lock acting on the shelf part 7 and the sliding carriage 54 is released, causing both to return, driven by the return spring 68, to the configuration shown in FIG. 9.

FIG. 11 shows a similar section to FIG. 9 through an assembly according to a third embodiment of the invention. The external shape of the base part 6, the sliding carriage 54 and the shelf part 7 is essentially the same as in the case of the second embodiment described with reference to FIGS. 6 to 10. Only the bar 69 has been omitted. It is replaced by a bar 73, of which a lower end is pivotable about a fixed pin 74 on the housing of the mechanism module 25 and from which an upper end projects through a slot 75 extending at right angles to the sectional plane of FIG. 11 from the housing of the mechanism module 25 and into a groove 76 formed at the top of the insertion slot 24.

FIG. 12 shows a view from below of this top of the insertion slot 24 and the groove 76 formed therein, as well as various positions that the bar 73 can assume in this groove 76.

The closed position of the shelf part 7 shown in FIG. 11 corresponds to a position of the bar 73 at a rear end of the groove 76, as designated by 73a in FIG. 12. If the shelf part 7 is swung out, thereby causing the sliding carriage 54 to slide forward (or to the right in FIGS. 11, 12), the bar 73 moves forward along a rectilinear section 76a of the groove 76 via a position designated by 73b in FIG. 12. Shortly before the shelf part 7 reaches a stop position defined as shown in FIG. 10 by the contact of the projection 71 with the spindle 72, the bar 73 reaches a curved section 76b of the groove 76 and follows this, pivoting about the pin 74 as far as a stop position 73c. If the user releases the shelf part 7 at this stop position and said shelf part, driven by the return spring 68, pivots upward again, the bar 73 does not return by the previously traveled path in the groove 76, but enters a second curved section 76c of the groove 76 and runs through this as far as a stop position designated by 73d, in which the contact of the pin 74 with the walls of the groove prevents a further closing of the shelf part 7. This is therefore situated in a stable open position in which, as in the locked position of FIG. 9, a container can be placed on the shelf part 7 or in the base part 6 for filling.

If, after the container has been filled, the user swivels the shelf part 7 a second time beyond the locked position, by further pivoting about the pin 74 the bar 73 reaches a third stop position 73e via a section 76d of the groove 76, from which third position the bar 73 can return to the starting position 73a by a path designated by 76e and thereby return the shelf part 7 to its closed position. In other words, by pivoting up the shelf part 7 once, the latter reaches a stable open position, and by pivoting it again in the same direction and then releasing it, it returns, driven by the return spring 68, to the closed position.

In order to avoid a violent closing movement of the shelf part 7 accompanied by generation of noise, the closing movement of the shelf part 7 can be braked by friction, of the toothed wheels 60 to 64 for example, or a flywheel coupled to one of the toothed wheels 60 to 64 can be accommodated in the mechanism module 25, said flywheel being accelerated in a starting phase of the closing movement and thereby slowing down the closing movement and driving it possibly in an end phase in which the resetting force of the spring 68 is now only small.

1-21. (canceled)

22. A dispensing device for dispensing flowable products, the dispensing device comprising:
a front side;
a recess in which a container can be disposed for receiving flowable products dispensed by the dispensing device, the recess being located at the front side of the dispensing device;
a dispenser opening located relative to the recess for passage of flowable products through the dispenser opening into the recess; and
a shelf part having a first shelf surface on which a container for receiving flowable products can be disposed, the shelf part being mounted for movement of the shelf part in a guided manner at the recess between a first position in which the first shelf surface is disposed opposite the dispenser opening at a first distance from the dispenser opening and a second position in which the first shelf surface is disposed opposite the dispenser opening at a second distance that is greater than the first distance.

23. The dispensing device as claimed in claim 22, wherein the shelf part includes a second shelf surface, the second shelf surface being positioned relative to the first shelf surface such that, in the first position of the shelf part, at least a portion of the first shelf surface is intermediate the dispenser opening and the second shelf surface.

24. The dispensing device as claimed in claim 23, wherein a respective shelf surface is located opposite the dispenser opening at the second position of the shelf part for supporting the container and the respective shelf surface is the first shelf surface.

25. The dispensing device as claimed in claim 23, wherein a respective shelf surface is located opposite the dispenser opening at the second position of the shelf part for supporting the container and the respective shelf surface is a third shelf surface formed on the shelf part.

26. The dispensing device as claimed in claim 22, wherein the shelf part is situated inside the recess in the first position and is situated at least partially outside the recess in the second position.

27. The dispensing device as claimed in claim 22 and further comprising a restoring element operable to return the shelf part from its second position to the first position.

28. The dispensing device as claimed in claim 27, wherein the shelf part can be latched in the second position.

29. The dispensing device as claimed in claim 28 and further comprising a bar and a bar release element and, in the second position, the shelf part is latched in place by the bar, the bar can be moved by actuation of the bar release element to effect release of the shelf part from its latched disposition, and, in the event that the bar release element is a button, the bar can be moved by pressing the button in order to effect release of the shelf part from its latched disposition.

30. The dispensing device as claimed in claim 28, wherein the shelf part can be latched in the second position by means of a single movement from the first position beyond the second position, and can be unlatched by means of a repeated movement beyond the second position.

31. The dispensing device as claimed in claim 22 and further comprising a sliding carriage, the sliding carriage being displaceable in a depth direction of the recess and being operable to maintain the shelf part at the recess.

32. The dispensing device as claimed in claim 31, wherein the dispensing device is a built-in device.

33. The dispensing device as claimed in claim 31, wherein a displacement of the sliding carriage is coupled to the movement of the shelf part and the sliding carriage assumes a position retracted into the recess when the shelf part is in the first position, and a position extended out of the recess when the shelf part is in the second position.

34. The dispensing device as claimed in claim 33 and further comprising a stationary toothed rack and the sliding carriage includes a gear mechanism that is driven by a movement of the shelf part between the first and the second positions and that is coupled to the stationary toothed rack.

35. The dispensing device as claimed in claim 31 and further comprising a base part detachably secured in the recess and the sliding carriage is guided at the base part.

36. The dispensing device as claimed in claim 35, wherein the shelf part is hinged to the sliding carriage.

37. The dispensing device as claimed in claim 31 and further comprising a base part detachably secured in the recess and the shelf part is hingedly secured to the base part.

38. The dispensing device as claimed in claim 37, wherein the base part functions as a liner to line at least a lower region of the recess.

39. The dispensing device as claimed in claim 37, wherein the base part is guided in the recess by means of rails which extend in a withdrawal direction of the base part and the base part is secured by a pin disposed at a selected one of a right angle relative to the withdrawal direction and a non-right angle relative to the withdrawal direction.

40. The dispensing device as claimed in claim 37, wherein the base part includes a projection and the recess includes a cavity, the projection of the base part and the cavity of the recess both extend in the withdrawal direction of the base part, and the base part is secured by a pin disposed at a selected one of a right angle relative to the withdrawal direction and a non-right angle relative to the withdrawal direction.

41. The dispensing device as claimed in claim 39, wherein, in the first position of the shelf part, the pin is concealed by the shelf part.
